(19) United States
(12) Patent Application Publication
(10) Pub. No.: US 2023/0044015 A1
(43) Pub. Date: Feb. 9, 2023

(54) SYSTEMS AND METHODS FOR IMPROVING ACCURACY OF PASSENGER PICK-UP LOCATION FOR AUTONOMOUS VEHICLES

(71) Applicant: GM Cruise Holdings LLC, San Francisco, CA (US)

(72) Inventors: Shahram Rezaei, Danville, CA (US); Parinaz Sayyah, Los Gatos, CA (US)

(73) Assignee: GM Cruise Holdings LLC, San Francisco, CA (US)

(21) Appl. No.: 17/394,472

(22) Filed: Aug. 5, 2021

(51) Int. Cl. G06Q 10/06; G01S 13/46; H04W 4/029; B60W 60/00

(52) U.S. Cl. CPC G06Q 10/0631; G01S 13/46; H04W 4/029; B60W 60/00253; G01S 2013/468; B60W 2556/45

(57) ABSTRACT

Systems and methods for determining precise pick-up locations for passengers who have requested autonomous vehicle rides. In particular, systems and methods are provided for using wireless signals to determine user location. In some examples, wireless ranging technology, such as Ultra Wide Band (UWB), is used to determine the user location. Wireless transceivers are used to determine a mobile device's range, and range information from multiple transceivers is used to determine the mobile's device's position. In some examples, triangulation is used to determine user location, such as triangulation between one or more wireless transceivers and the mobile device. In various examples, wireless transceivers are installed on autonomous vehicles, and in some examples, wireless transceivers are installed in various static locations (e.g., on buildings, lamp posts, or other structures.

### FIELD OF THE DISCLOSURE

The present disclosure relates generally to autonomous vehicles (AVs) and to systems and methods for determining passenger location.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations.

According to an exemplary interaction scenario, a passenger who desires to be picked up for a ride may hail an autonomous vehicle by sending a request utilizing a computing device (e.g., a mobile computing device). Responsive to the request, a particular autonomous vehicle from a fleet of autonomous vehicles can be assigned to provide a ride for the passenger to be picked up. The autonomous vehicle, for instance, may need to travel to a pickup location to meet the passenger to be picked up.

Currently, most of the dispatch systems for autonomous vehicles rely on the position information provided by the user's mobile device's GPS to identify the pick-up locations. In contrast, autonomous vehicles typically utilize several sensors, such as LIDAR, camera, IMU, and high precision GPS, together with a high definition map to achieve centimeter-level accuracy of positioning and navigation. The user mobile device GPS has about meter-level accuracy and the accuracy degrades significantly in places with GPS signal obstructions, like in urban canyon environments. Thus, the provided pick-up location through phone and tablet devices can have several meter errors from the true passenger position.

### SUMMARY

Systems and methods are provided for providing precise pick-up locations for passengers who have requested autonomous vehicle rides. In particular, systems and methods are provided for using wireless signals to determine user location. In some examples, wireless ranging technology, such as Ultra Wide Band (UWB), is used to determine the user location. Wireless transceivers are used to determine a mobile device's range, and range information from multiple transceivers is used to determine the mobile's device's position. In some examples, triangulation is used to determine user location, such as triangulation between one or more wireless transceivers and the mobile device. In various examples, wireless transceivers are installed on autonomous vehicles, and in some examples, wireless transceivers are installed in various static locations (e.g., on buildings, lamp posts, or other structures). Additionally, many mobile devices include wireless transceivers.

According to one aspect, a method for precise pick-up location determination includes assigning a first autonomous vehicle to a user via a mobile device; determining an approximate pick-up location, determining, at a first wireless ranging technology unit, a first distance and a first angle between the mobile device and the first wireless ranging technology unit, determining, at a second wireless ranging technology unit, a second distance and a second angle between the mobile device and the second wireless ranging technology unit, and determining a mobile device location based on the first and second distances and the first and second angles, wherein the mobile device location is the precise pick-up location.

According to some implementations, determining the mobile device location further comprises performing triangulation using the first and second distances and the first and second angles. In some implementations, the method includes communicating the first distance and the first angle from the first wireless ranging technology unit with the second wireless ranging technology unit. In some implementations, the method includes communicating the first and second distances and the first and second angles from the first and second wireless ranging technology units with a central computing system. In some implementations, the method includes communicating the first and second distances and the first and second angles from the first and second wireless ranging technology units with the mobile device. In some implementations, the method includes sharing the mobile device location with the first autonomous vehicle. In some implementations, the method includes determining, at the first autonomous vehicle, a stopping location based, at least in part, on the mobile device location. In some examples, determining the first and second distances includes performing time of flight measurements.

According to another aspect, a system for user pick-up location determination in an autonomous vehicle fleet, comprises a first autonomous vehicle; a central computing system configured to assign the first autonomous vehicle to a user via a mobile device for a user ride, a first wireless ranging technology unit configured to determine a first distance and a first angle between the user mobile device and the first wireless ranging technology unit, and a second wireless ranging technology unit configured to determine a second distance and a second angle between the user mobile device and the second wireless ranging technology unit, wherein the first and second distances and the first and second angles are used for the user pick-up location determination.

According to some implementations, at least one of the first autonomous vehicle, the central computing system, and the mobile device is configured to receive the first and second distances and the first and second angles and determine the user pick-up location. In some implementations, at least one of the first autonomous vehicle, the central computing system, and the mobile device is configured perform triangulation using the first and second distances and the first and second angles to determine the user pick-up location. In some implementations, the first and second wireless ranging technology units include Ultra Wide Band transmitters. In some implementations, at least one of the first and second wireless ranging technology units is attached to a stationary structure. In some implementations, at least one of the first and second wireless ranging technology units is positioned on a second autonomous vehicle in the autonomous vehicle fleet. In some implementations, at least one of the first and second wireless ranging technology units is positioned in a second mobile device. In some implementations, the mobile device includes a rideshare application for the fleet of autonomous vehicles, and wherein the rideshare application is configured to activate user pick-up location determination.

According to another aspect, a system for user pick-up location determination in an autonomous vehicle, comprises a central computing system including a routing coordinator and an onboard computing system on the first autonomous vehicle. The routing coordinator is configured to receive a ride request from a mobile device including a pick-up location, and select a first autonomous vehicle for fulfilling the ride request. The onboard computing system on the first autonomous vehicle configured to receive a first distance and a first angle between the mobile device and a first wireless ranging technology unit, receive a second distance and a second angle between the mobile device and a second wireless ranging technology unit, and determine a mobile device location based on the first and second distances and the first and second angles.

According to various implementations, the onboard computing system is further configured to determine a stopping location based at least in part on the mobile device location. In some implementations, the onboard computing system is further configured to perform triangulation using the first and second distances and the first and second angles. In some implementations, the first and second wireless ranging technology units include Ultra Wide Band transmitters.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a diagram illustrating a method for autonomous vehicle location determination, according to various embodiments of the disclosure;

FIGS. 3A-3D illustrate various mobile device location determination environments, according to various embodiments of the disclosure;

FIGS. 4A and 4B show examples of a device interface for vehicle location determination, according to some embodiments of the disclosure.

FIG. 5 is a diagram illustrating a fleet of autonomous vehicles in communication with a central computer, according to some embodiments of the disclosure; and

FIG. 6 shows an example embodiment of a system for implementing certain aspects of the present technology.

### DETAILED DESCRIPTION

Overview

Systems and methods are provided for providing precise pick-up locations for passengers who have requested autonomous vehicle rides. In particular, systems and methods are provided for using wireless signals from a user mobile device to determine user location. In some examples, wireless ranging technology, such as Ultra Wide Band (UWB), is used to determine the user location. Wireless transceivers are used to determine a mobile device's range, and range information from multiple transceivers is used to determine the mobile's device's position. In some examples, triangulation is used to determine user location, such as triangulation between one or more wireless transceivers and the mobile device. In various examples, wireless transceivers are installed on autonomous vehicles, and in some examples, wireless transceivers are installed in various static locations (e.g., on buildings, lamp posts, or other structures).

Autonomous vehicles typically utilize several sensors together with a high definition map to achieve centimeter-level accuracy of vehicle positioning, and for navigation. The sensors can include LIDAR, camera, IMU (Inertial Measurement Unit), and high precision GNSS (Global Navigation Satellite System, also known as Global Positioning system (GPS)). In contrast, dispatch systems for identifying user pick-up locations for autonomous vehicle rides rely on the position information provided by the user's mobile device GNSS. The GNSS in mobile devices has only meter-level accuracy (much less accuracy than autonomous vehicle position accuracy) and the mobile device accuracy degrades significantly in places with GNSS signal obstructions. Places with GNSS signal obstructions include urban canyon environments, such as city streets and sidewalks with buildings on both sides, blocking GNSS signals. Thus, the provided pick-up location through a user mobile device can be off by several meters from the true mobile device position.

The mobile device positioning accuracy also declines depending on the model of the mobile device (due to the quality of the GNSS antenna inside, interference with other wireless devices and parts within the phone, etc). In today's non-automated driving ride-hailing services (Uber, Lyft, etc), in GNSS challenging environments (for example, downtown San Francisco), the driver often has to call the passenger via phone to locate the passenger and coordinate the pick-up. In the absence of the driver, an autonomous vehicle cannot utilize such communications. Lack of a precise pickup location on busy streets or at buildings with multiple entrances makes it challenging for an autonomous vehicle to determine the best pull-over spot relative to the precise location of the passenger(s). Additionally, lack of precise pick-up location makes it difficult for an autonomous vehicle to calculate the pull-over distance in real-time to maneuver the vehicle accordingly. This leads to inaccurate estimated times of arrival of autonomous vehicles and customer dissatisfaction.

Additionally, in crowded scenarios, such as after a concert or sporting event, autonomous vehicles need an easy method of determining the location of the assigned passenger. Similarly, passengers need to identify their assigned autonomous vehicle. Having a precise pick-up location for the passenger allows the autonomous vehicle to stop in close proximity to the passenger, which also makes it much easier for the passengers to identify their assigned autonomous vehicle.

As described below, systems and methods are provided for precise positioning of a user's mobile device using wireless ranging technology.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

### Example Autonomous Vehicle Configured for Mobile Device Location Determination

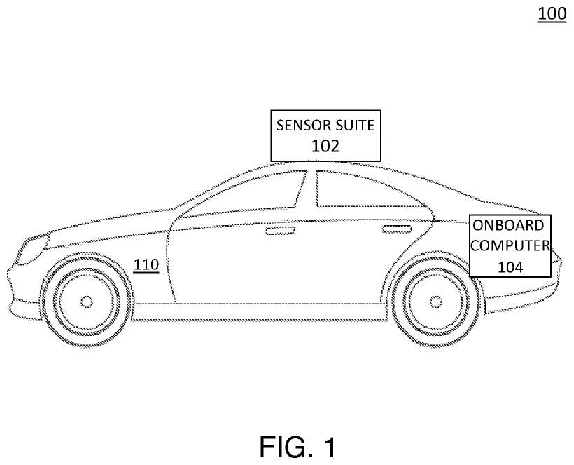

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. The autonomous vehicle 110 is configured to stop at or close to the pick-up location of an assigned passenger.

The sensor suite 102 includes localization and driving sensors. For example, the sensor suite may include one or more of photodetectors, cameras, RADAR, SONAR, LIDAR, GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment and, in some examples, sensor suite 102 data is used to detect selected events. In particular, data from the sensor suite 102 can be used to update a map with information used to develop layers with waypoints identifying selected events, the locations of the encountered events, and the frequency with which the events are encountered at the identified location. In some examples, data from the sensor suite 102 can include information regarding crowds and/or lines outside and/or around selected venues. Additionally, sensor suite 102 data can provide localized traffic information. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

In some examples, the sensor suite 102 includes wireless ranging technology, such as one or more of a UWB transceiver, a UWB receiver, and a UWB transmitter. The UWB transceiver/transmitter is configured to transmit UWB signals. The UWB transceiver/receiver is configured to receive UWB signals. Using the wireless ranging technology, the sensor suite 102 can determine the distance between the autonomous vehicle 110 and a mobile device. In some examples, the distance is transmitted to a central computer for determining mobile device location. In some examples, the autonomous vehicle 110 receives additional mobile device range information such as the distance between the autonomous vehicle 110 and another mobile device, and/or the distance between the mobile device and a roadside wireless ranging technology unit, and/or the distance between another autonomous vehicle and the mobile device. The autonomous vehicle 110 uses the additional range information to determine the mobile device location.

In some implementations, the sensor suite 102 can be used to detect nearby passengers, for example via a rideshare application on passenger mobile devices. The sensor suite 102 can track movement of nearby passengers. In some implementations, the sensor suite 102 can be used to detect nearby autonomous vehicles in the same fleet as the autonomous vehicle 110, and track movement of nearby the autonomous vehicles.

In some implementations, data from the sensor suite 102 can be used to detect a passenger exiting a vehicle and/or to determine that a passenger has exited a vehicle. In some examples, a passenger drop-off determination is satisfied by detecting that a passenger has exited the vehicle. For instance, interior and/or exterior cameras can be used to detect that a passenger has exited the vehicle. In some examples, other interior and/or exterior sensors can be used to detect that a passenger has exited the vehicle.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. The cameras can be used to detect items or people inside the vehicle. Additionally, the cameras can be used to automatically and/or manually capture images of passengers inside the vehicle. In some examples, the autonomous vehicle 110 includes one or more weight sensors inside the vehicle, which can be used to detect items or people inside the vehicle. In some examples, the interior sensors can be used to detect passengers inside the vehicle. In some examples, the autonomous vehicle 110 includes one or more lights inside the vehicle, and selected lights can be illuminated as an indication to an approaching passenger of whether the autonomous vehicle is assigned to the approaching passenger. In one example, if the autonomous vehicle is assigned to the approaching passenger, green lights are illuminated. In contrast, in another example, if the autonomous vehicle is not assigned to the approaching passenger, red lights are illuminated. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some examples, the onboard computer 104 determines the location of the mobile device of the assigned passenger using the wireless range data from the sensor suite 102 as well as additional wireless range data as described above. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

Method for Mobile Device Location Determination

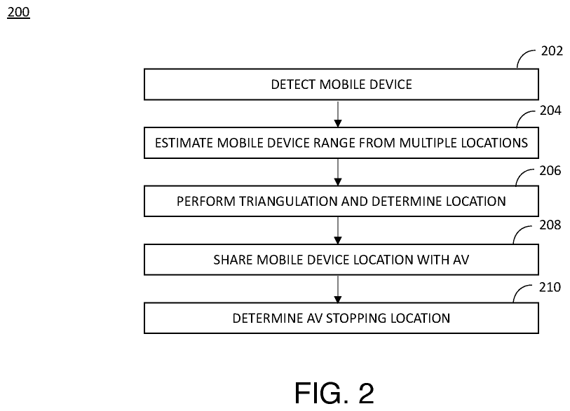

FIG. 2 is a diagram illustrating a method 200 for mobile device location determination, according to various embodiments of the disclosure. In particular, the method 200 is a method for determining the location of a mobile device using wireless ranging technology. The wireless ranging technology can include any wireless signals. Some examples of wireless ranging technology include Ultra Wide Band technology, 5G New Radio (NR), and other cellular-based technologies. In some examples, the wireless signal has a range of between about 50 meters and about 100 meters. The mobile device location can be used to determine the pick-up location of an autonomous vehicle passenger, and thus to determine where the assigned autonomous vehicle should stop to pick up the passenger.

At step 202, the passenger's mobile device is detected. In particular, at step 202, wireless ranging technology is used for detection of the passenger's mobile device. In some examples, the mobile device receives a wireless signal from a wireless ranging technology transmitter. The wireless ranging technology transmitter can be a stationary transmitter positioned on a local structure, and it can be a transmitter in/on a nearby autonomous vehicle. In some examples, the user's mobile device transmits a wireless signal that is received by a wireless ranging technology receiver. The wireless ranging technology receiver may be a stationary receiver positioned on a local structure, and it may be a receiver in a sensor suite of a nearby autonomous vehicle.

At step 204, the mobile device range is estimated from multiple locations. In one example, a first wireless signal transmitter signal is received at the mobile device, and a second wireless signal transmitter signal is received at the mobile device. A first distance between the first wireless signal transmitter and the mobile device is determined. In some examples, the first distance is determined at one of the first and second transmitter units. In other examples, the first distance is determined at a backend server. In further examples, the first distance is determined at the mobile device. Similarly, a second distance between the second wireless signal transmitter and the mobile device is determined. In various examples, the second distance is determined at one of the first and second wireless transmitter units, a backend server, and the mobile device. According to various implementations, the first and second distances are estimated distances. In various examples, one or more of the first and second wireless signal transmitters can be a stationary transmitter attached to a structure, a transmitter on an autonomous vehicle, or a transmitter from another mobile device. In some examples, the transmitters use Ultra Wide Band (UWB) technology and transmit information across a wide bandwidth.

In another example, the mobile device transmits a wireless signal that is received at a first receiver and at a second receiver. A first distance between the mobile device and a first receiver is determined, and a second distance between the mobile device and a second receiver is determined. In various examples, the first distance is determined at one of the first and second receivers, a backend server, and the mobile device. Similarly, in various examples, the second distance is determined at one of the first and second receivers, a backend server, and the mobile device.

According to various implementations, the first and second distances are estimated distances. In various examples, one or more of the first and second wireless signal receivers can be a stationary receiver attached to a structure, a receiver on an autonomous vehicle, or a receiver in another mobile device.

At step 206, the location of the mobile device is determined. In particular, using the first and second distances, triangulation can be used to determine the mobile device location. According to one implementation, triangulation to determine the mobile device location is performed at a backend server, such as at a central computing system for a rideshare service. In another example, triangulation to determine the mobile device location is performed at the mobile device. In another example, triangulation to determine the mobile device location is performed at a nearby autonomous vehicle. In a further example, triangulation to determine the mobile device location is performed at a nearby transceiver, transmitter, or receiver.

At step 208, the location of the mobile device is provided to the assigned autonomous vehicle. In some examples, the mobile device location is determined by the mobile device and shared with the rideshare application, which provides the location to the assigned autonomous vehicle. In other examples, the mobile device location is determined by a backend server such as the central computing system for the rideshare application, and the central computing system provides the mobile device location to the assigned autonomous vehicle. In some examples, a nearby wireless transceiver, transmitter, and/or receiver determines the mobile device location, and shares the location with a rideshare central computing system which provides the location to the assigned autonomous vehicle. In other examples, a nearby wireless transceiver, transmitter, and/or receiver determines the mobile device location, and shares the location directly with the assigned autonomous vehicle. In further examples, a nearby unassigned autonomous vehicle determines the mobile device location and shares the location either directly with the assigned autonomous vehicle or with the rideshare central computing system, which provides the location to the assigned autonomous vehicle.

At step 210, the assigned autonomous vehicle uses the received mobile device location to determine a stopping location. According to various examples, the stopping location depends on local traffic, available parking spaces, available spaces to pull over, and other local conditions determined by the assigned autonomous vehicle. The assigned autonomous vehicle selects the available stopping location that is closest to the mobile device location (which is the passenger pick-up location).

In various implementations, the mobile device location is updated over time since the passenger can move after an initial mobile device location determination. In one example, a passenger detects an available pick-up location, such as a vehicle stopping lane and/or an open parking space, and walks towards that location. The mobile device location changes as the passenger moves. Thus, steps 204-210 of the method 200 can be repeated as the mobile device location changes with passenger movement towards a particular location. In some examples, the pick-up location is projected based on the movement of the mobile device over time.

### Example Mobile Device Location Determination Environment

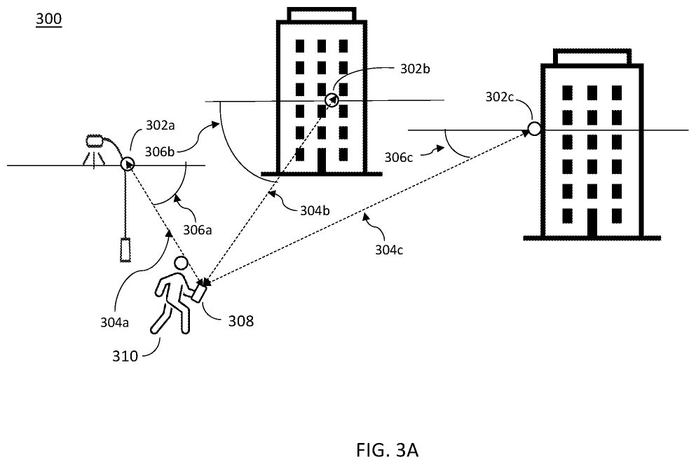

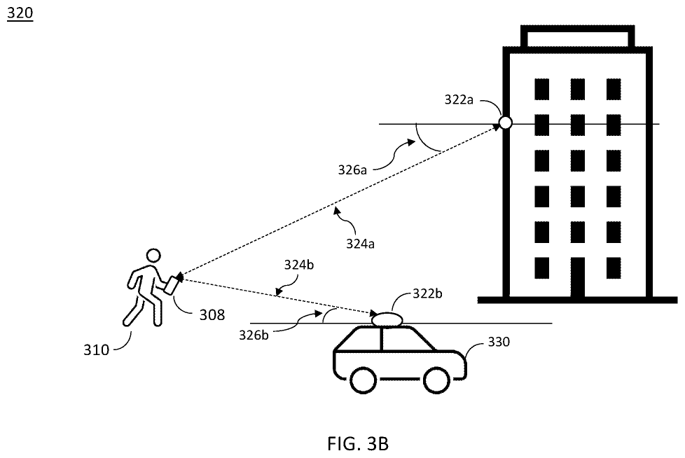

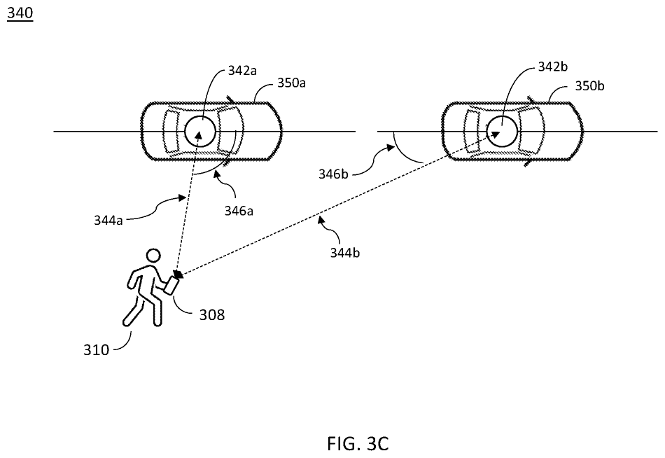

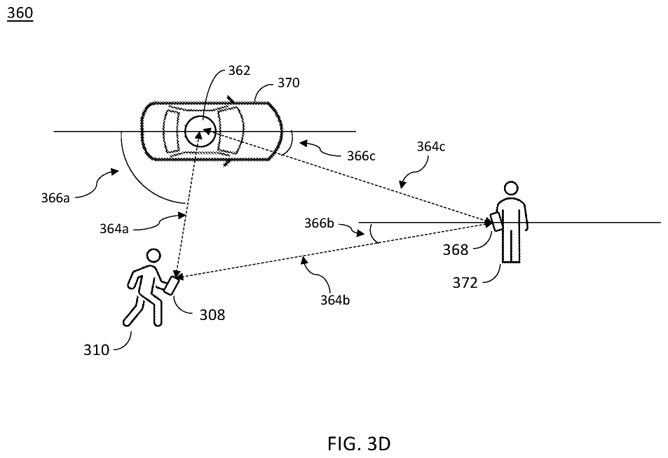

FIGS. 3A-3D illustrate various mobile device location determination environments, according to various embodiments of the disclosure. FIG. 3A illustrates an environment 300 with first 302a, second 302b, and third 302c wireless ranging technology roadside units including transceivers, according to various embodiments of the disclosure. In some examples, the first 302a, second 302b, and third 302c roadside units include Ultra Wide Band transmitters, transceivers, and/or receivers. The first 302a, second 302b, and third 302c roadside units determine the time of flight between the unit and a mobile device to determine a distance between the unit and the mobile device. The environment 300 exemplifies a smart intersection. In various examples, many city intersections can be set up like the scenario 300 with wireless ranging technology transceivers in communication with mobile devices.

The first 302a, second 302b, and third 302c roadside units are installed at known locations. As shown in the scenario 300, the first roadside unit 302a is installed on a lamp post, and the second 302b and third 302c roadside units are installed on buildings. When a mobile device 308 comes within range of one or more of the roadside units 302a, 302b, 302c, the roadside unit 302a, 302b, 302c estimates the distance between it and the mobile device. Each of the first 302a, second 302b, and third 302c roadside units are within a communications range of the mobile device 308. In some examples, the mobile device 308 is less than about 100 meters from each of the first 302a, second 302b, and third 302c roadside units. The mobile device 308 is a first distance 304a from the first roadside unit 302a. The mobile device 308 is a second distance 304b from the second roadside unit 302b. The mobile device 308 is a third distance 304c from the third roadside unit 302c. Additionally, there is a first angle 306a between the mobile device 308 and the first roadside unit 302a. There is a second angle 306b between the mobile device 308 and the second roadside unit 302b. There is a third angle 306c between the mobile device 308 and the third roadside unit 302c. According to various implementations, the angle of arrival is estimated by measurement of the difference in the signal carrier arrival at multiple receiver antennas. Using this measurement, the angle of arrival is relative to the receiver's antennas.

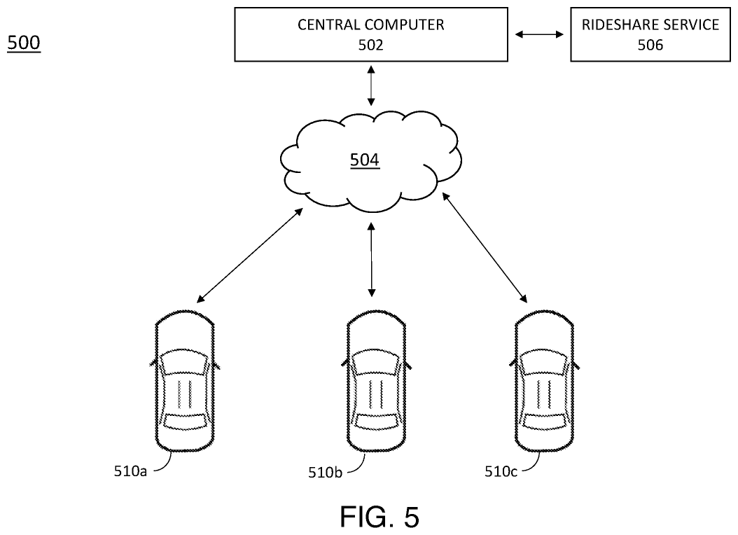

According to some implementations, the first 302a, second 302b, and third 302c roadside units communicate with each other to share distance and angle information. In some implementations, the first 302a, second 302b, and third 302c roadside units communicate with a backend server (such as the central computing system of FIG. 5 below) to share data. In one example, the first 302a, second 302b, and third 302c roadside units communicate with the backend server via cellular communication.

The first 304a, second 304b, and third distances 304c, as well as the first 306a, second 306b, and third 306c angles can be used to determine the location of the mobile device 308. The location determination can be made at one of the roadside units 302a, 302b, 302c, or the location determination can be made at the backend server. The location of the mobile device is shared with the assigned autonomous vehicle. According to various implementations, the mobile device location changes over time, and the first 302a, second 302b, and third 302c roadside units periodically update the respective distances 304a, 304b, 304c as well as the respective angles 306a, 306b, 306c.

In some implementations, the first 302a, second 302b, and third 302c roadside units send the respective distances 304a, 304b, 304c and the respective angles 306a, 306b, 306c to the mobile device 308. The mobile device 308 includes an application that receives the distance 304a, 304b, 304c and angle 306a, 306b, 306c information and determines its location. In some examples, the mobile device 308 receives the distance 304a, 304b, 304c and angle 306a, 306b, 306c information from the backend server (a central computing system). In some examples, an application on the mobile device 308 processes the distance 304a, 304b, 304c and angle 306a, 306b, 306c information to determine the mobile device 308 location. In some examples, a mobile device 308 operating system processes the distance 304a, 304b, 304c and angle 306a, 306b, 306c information to determine the mobile device 308 location. In various examples, the distance 304a, 304b, 304c and angle 306a, 306b, 306c information is used in a triangulation algorithm to determine mobile device 308 location. In some examples, a Kalman filter is used to fuse distance and angle measurements and perform triangulation. In some examples, an extended Kalman filter fuses distance and angle measurements together with other device sensor measurements, such as GNSS-measured position, IMU acceleration and IMU angular rate.

In some implementations, the mobile device 308 GNSS data is used to estimate a general mobile device 308 location. In some implementations, a mobile device 308 user 310 selects an approximate location on a map on the mobile device 308. The approximate location information can be used to initialize and/or fuse with the wide ranging technology distance information.

FIG. 3B illustrates an environment 320 with two wireless ranging technology units, a first static roadside unit 322a and second wireless ranging technology unit 322b on a nearby autonomous vehicle 330, according to various embodiments of the disclosure. The first wireless ranging technology roadside unit 322a is installed at known location and remains stationary, on the side of a building. The second wireless ranging technology unit 322b is mobile, and its location is determined by the location of the autonomous vehicle 339. Since autonomous vehicle location is known to centimeter-level accuracy, as described above, the location of the second wireless ranging technology unit is also known to centimeter-level accuracy.

When a mobile device 308 comes within range of one or more of the roadside units 322a, 322b, the roadside unit 322a, 322b estimates the distance between it and the mobile device 308, for example using time of flight technology. Each of the first 322a and second 322b wireless ranging technology units are within a communications range of the mobile device 308. In some examples, the mobile device 308 is less than about 100 meters from each of the first 322a and second 322b wireless ranging technology units. The mobile device 308 is a first distance 324a from the first wireless ranging technology unit 322a. The mobile device 308 is a second distance 324b from the second wireless ranging technology unit 322b. Additionally, there is a first angle 326a between the mobile device 308 and the first wireless ranging technology unit 322a. There is a second angle 326b between the mobile device 308 and the second wireless ranging technology unit 322b.

As discussed above with respect to FIG. 3A, the distance 324a, 324b and angle 326a, 326b information can be used in a triangulation algorithm to determine mobile device 308 location. In some examples, the mobile device 308 location is determined by the mobile device 308, after the distance 324a, 324b and angle 326a, 326b information is shared with the mobile device. In some examples, the mobile device 308 location is determined.

In various examples, the location determination can be made at one of the wireless ranging technology units 322a, 322b, at the backend server (central computing system), on the mobile device, or using the onboard computer of the assigned autonomous vehicle. The location of the mobile device 308 is shared with the assigned autonomous vehicle. According to various implementations, the mobile device 308 location changes over time, and first 322a and second 322b wireless ranging technology units periodically update the respective distances 324a, 324b and angles 326a, 326b.

FIG. 3C illustrates an environment 340 with first 342a and second 342b wireless ranging technology units, both on autonomous vehicles, according to various embodiments of the disclosure. In particular, the first wireless ranging technology unit 342a is on a first autonomous vehicle 350a and the second wireless ranging technology unit 342b is on a second autonomous vehicle 350b. While the first 342a and second 342b wireless ranging technology units are both mobile, the precise location of each unit is known based on precise location information for the first 350a and second 350b autonomous vehicles. According to various examples, each of the first 342a and second 342b wireless ranging technology units uses Ultra Wide Band technology.

When a mobile device 308 comes within range of one or more of the wireless ranging technology units 342a, 342b (or the wireless ranging technology units 342a, 342b comes within range of the mobile device 308), the wireless ranging technology unit 342a, 342b estimates the distance between it and the mobile device 308. In the scenario 340, each of the first 342a and second 342b wireless ranging technology units are within a communications range of the mobile device 308. In some examples, the mobile device 308 is less than about 100 meters from each of the first 342a and second 342b wireless ranging technology units. The mobile device 308 is a first distance 344a from the first wireless ranging technology unit 342a. The mobile device 308 is a second distance 344b from the second wireless ranging technology unit 342b. Additionally, there is a first angle 346a between the mobile device 308 and the first wireless ranging technology unit 342a. There is a second angle 346b between the mobile device 308 and the second wireless ranging technology 342b.

According to some implementations, the first 342a and second 342b wireless ranging technology units communicate with each other to share distance 344a, 344b and angle 346a, 346b information. In some implementations, first 342a and second 342b wireless ranging technology units communicate with a backend server (such as the central computing system of FIG. 5 below) to share data. In one example, the first 342a and second 342b wireless ranging technology units communicate with the backend server via cellular communication. In some implementations, the first 342a and second 342b wireless ranging technology units communicate with the assigned autonomous vehicle to share the distance 344a, 344b and angle 346a, 346b information. In some implementations, the first 342a and second 342b wireless ranging technology units communicate with the mobile device 308 to share the distance 344a, 344b and angle 346a, 346b information. In some examples, the mobile device 308 receives the distance 344a, 344b and angle 346a, 346b information from the backend server (a central computing system). In some examples, an application on the mobile device 308 processes the distance 344a, 344b and angle 346a, 346b information to determine the mobile device 308 location. In some examples, a mobile device 308 operating system processes the distance 344a, 344b and angle 346a, 346b information to determine the mobile device 308 location.

The distance 344a, 344b and angle 346a, 346b information can be used to determine the location of the mobile device 308. In various examples, the distance 344a, 344b and angle 346a, 346b information is used in a triangulation algorithm to determine mobile device 308 location. The location determination can be made at one of the wireless ranging technology units 342a, 342b, at the mobile device 308, at the assigned autonomous vehicle, or at a central computing system (or backend server). The location of the mobile device 308 is shared with the assigned autonomous vehicle. According to various implementations, the mobile device location changes over time, and the first 342a and second 342b wireless ranging technology units periodically update the respective distances 344a, 344b, as well as the respective angles 346a, 346b.

In some implementations, the mobile device 308 GNSS data is used to estimate a general mobile device 308 location. In some implementations, a mobile device 308 user 310 selects an approximate location on a map on the mobile device 308. The approximate location information can be used to initialize and/or fuse with the wide ranging technology distance information to determine a precise location of the mobile device 308.

FIG. 3D illustrates an environment 360 with a first wireless ranging technology unit 362 on an autonomous vehicle 370, an additional wireless ranging technology unit embedded in a second mobile device 368 of a second user 372, according to various embodiments of the disclosure. The first wireless ranging technology unit 362 is mobile, but its precise location is known based on the precise location information for the first autonomous vehicle 370. According to various examples, each of the first wireless ranging technology unit 362 uses Ultra Wide Band technology. Similarly, according to various examples, the second mobile device 368 also uses Ultra Wide Band technology.

When the first mobile device 308 comes within range of the first wireless ranging technology unit 362, the first wireless ranging technology unit 362 determines the distance between it and the mobile device 308. Similarly, when the first mobile device 308 comes within range of the second mobile device 368, one or both of the first 308 and second 368 mobile devices determines the distance between the first 308 and second 368 mobile devices. In various examples, the location of the second mobile device 368 is approximate and based on GNSS information from the second mobile device 368. In some examples, the location of the second mobile device 368 is known based on wireless ranging technology triangulation with other wireless ranging technology units.

The first mobile device 308 is a first distance 364a from the first wireless ranging technology unit 362. The first mobile device 308 is a second distance 364b from the second mobile device 368. Additionally, there is a first angle 366a between the first mobile device 308 and the first wireless ranging technology unit 362. There is a second angle 366b between the first mobile device 308 and the second mobile device 368. Additionally, there is a third distance 364c between the second mobile device 368 and the first wireless ranging technology unit 362, and a third angle 366c between the second mobile device 368 and the first wireless ranging technology unit 362.

According to some implementations, the first wireless device 308 and the second wireless device 368 communicate with the first wireless ranging technology unit 362 to share distance 364a, 364b, 364c and angle 366a, 366b, 366c information. In some implementations, first 308 and second 368 wireless devices, and the first wireless ranging technology unit 362 communicate with a backend server (such as the central computing system of FIG. 5 below) to share data. In one example, the first 308 and second 368 wireless devices, and the first wireless ranging technology unit 362 communicate with the backend server via cellular communication. In some implementations, the first 308 and second 368 wireless devices, and the first wireless ranging technology unit 362 communicate with the assigned autonomous vehicle to share the distance 364a, 364b, 364c and angle 366a, 366b, 366c information. In some examples, the first mobile device 308 receives the distance 364a, 364b, 364c and angle 366a, 366b, 366c information from the backend server (a central computing system). In some examples, an application on the first mobile device 308 processes the distance 364a, 364b, 364c and angle 366a, 366b, 366c information to determine the mobile device 308 location. In some examples, a first mobile device 308 operating system processes the distance 364a, 364b, 364c and angle 366a, 366b, 366c information to determine the first mobile device 308 location.

In various examples, the distance 364a, 364b, 364c and angle 366a, 366b, 366c information is used in a triangulation algorithm to determine mobile device 308 location. The location determination can be made at the wireless ranging technology unit 362, at the first mobile device 308, at the assigned autonomous vehicle, or at a central computing system (or backend server). The location of the first mobile device 308 is shared with the assigned autonomous vehicle. According to various implementations, the first mobile device 308 location changes over time, and the first wireless ranging technology unit 362 periodically updates the respective distances 364a, 364b, 364c as well as the respective angles 366a, 366b, 366c.

In some implementations, the first mobile device 308 GNSS data is used to estimate a general mobile device 308 location. In some implementations, a first mobile device 308 user 310 selects an approximate location on a map on the mobile device 308. The approximate location information can be used to initialize and/or fuse with the wide ranging technology distance information to determine a precise location of the first mobile device 308. Similarly, in some implementations, the second mobile device 368 GNSS data is used to estimate a general location of the second mobile device 368.

### Example Device for Pick-up Location Determination

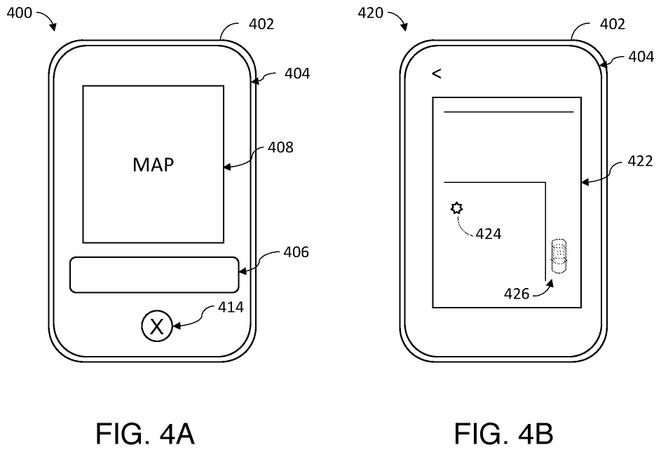

FIGS. 4A and 4B show examples 400, 420 of a device interface for vehicle location determination, according to some embodiments of the disclosure. In particular, FIG. 4A shows an example 400 of a device 402 showing a rideshare application interface 404 including a map 408 showing current user location, and providing the user the option to activate precise pick-up location determination via the button 406. According to the example shown in FIG. 4A, the rideshare application interface 404 also includes a close button 414. Selection of the close button 414 closes out of the interface 404, returning to a main (or previous) rideshare application interface. While in some examples, the interface 404 allows the user to activate precise pick-up location determination via the button 406, in other examples, the precise pick-up location determination is automatically activated with use of the rideshare application. In some examples, the button 406 activates an interactive map 422 as shown in FIG. 4B, on which the user can adjust the pick-up location to either the approximate current location or to a desired pick-up location.

According to various implementations, the rideshare application interface 604 displays on a user's mobile device 602 when the user approaches the pick-up location. In some examples, the button 606 activates the precise pick-up location determination, such as via the method 200 of FIG. 2. In other examples, the button 606 activates the interactive map 422 of FIG. 4B, on which the user can manually adjust the current location 424 and/or the pick-up location. In various examples, the mobile device 400 includes wireless ranging technology, which is activated when the user selects the button 406.

### Example of Autonomous Vehicle Fleet

FIG. 5 is a diagram 500 illustrating a fleet of autonomous vehicles 510a, 510b, 510c in communication with a central computer 502, according to some embodiments of the disclosure. As shown in FIG. 5, the vehicles 510a-510c communicate wirelessly with a cloud 504 and a central computer 502. The central computer 502 includes a routing coordinator and a database of information from the vehicles 510a-510c in the fleet. Autonomous vehicle fleet routing refers to the routing of multiple vehicles in a fleet. The central computer also acts as a centralized ride management system and communicates with rideshare users via a rideshare service 506. The vehicles 510a-510c can each be used to implement the mobile device location systems and methods of FIGS. 2 and 3A-3D, and/or to receive mobile device location information determined from the systems and method discussed with respect to FIGS. 2 and 3A-3D. In some implementations, the autonomous vehicles 510a-510c communicate directly with each other. In some implementations, each of the autonomous vehicles 510a-510c includes a wireless ranging technology unit.

When a passenger requests a ride through a rideshare service 506, the rideshare service 506 sends the request to central computer 502. The central computer 502 selects a vehicle 510a-510c based on the request. When the autonomous vehicle 510a-510c nears the general pick-up location, the autonomous vehicle 510a-510c receives and/or determines the mobile device location to more precisely determine the pick-up location and identify a stopping location. In some examples, the central computer 502 provides the vehicle 510a-510c with the mobile device location, and the vehicle 510a-510c determines a stopping location. In some examples, when several vehicles 510a-510c are present in the same general pick-up area, each vehicle 510a-510c can determine a distance to a passenger mobile device and for determining mobile device location. The vehicles 510a, 510b, 510c communicate with a central computer 502 via a cloud 504.

Once a destination is selected and the user has ordered a vehicle, the routing coordinator can optimize the routes to avoid traffic as well as to optimize vehicle occupancy. In some examples, an additional passenger can be picked up en route to the destination, and the additional passenger can have a different destination. In various implementations, since the routing coordinator has information on the routes for all the vehicles in the fleet, the routing coordinator can adjust vehicle routes to reduce congestion and increase vehicle occupancy. Note that in order for the routing coordinator to optimize routes and increase vehicle occupancy, it is important that passengers ride in the assigned vehicle and not a different vehicle in the fleet that is also present for a passenger pick-up at the same location.

As described above, each vehicle 510a-510c in the fleet of vehicles communicates with a routing coordinator. Thus, information gathered by various autonomous vehicles 510a-510c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more travelling preferences and/or routing goals, such as passing a photogenic location. In some examples, the routing coordinator uses collected position data corresponding to emergency events to generate a best route for an autonomous vehicle to avoid a potential emergency situation.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, view from the vehicle of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, laws, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, passenger safety, pedestrian safety, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, rideshare revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals take priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computing system 502 generates a route for each selected autonomous vehicle 510a-510c, and the routing coordinator determines a route for the autonomous vehicle 510a-510c to travel from the autonomous vehicle's current location to a destination.

### Example of a Computing System for Ride Requests

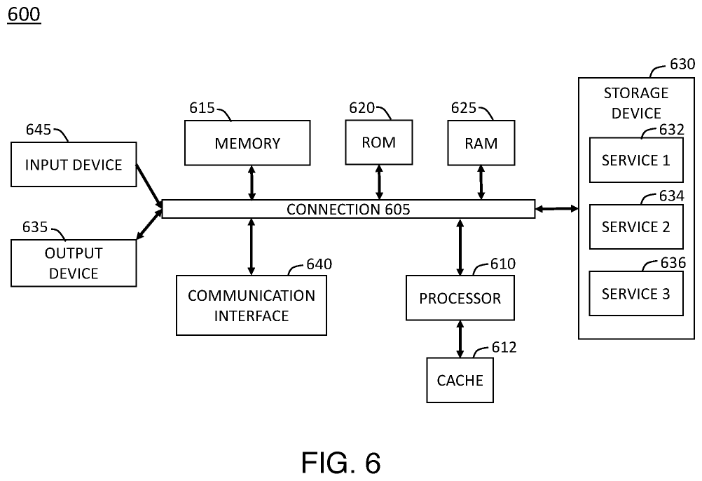

FIG. 6 shows an example embodiment of a computing system 600 for implementing certain aspects of the present technology. In various examples, the computing system 600 can be any computing device making up the onboard computer 104, the central computing system 502, or any other computing system described herein. The computing system 600 can include any component of a computing system described herein which the components of the system are in communication with each other using connection 605. The connection 605 can be a physical connection via a bus, or a direct connection into processor 610, such as in a chipset architecture. The connection 605 can also be a virtual connection, networked connection, or logical connection.

In some implementations, the computing system 600 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 600 includes at least one processing unit (CPU or processor) 610 and a connection 605 that couples various system components including system memory 615, such as read-only memory (ROM) 620 and random access memory (RAM) 625 to processor 610. The computing system 600 can include a cache of high-speed memory 612 connected directly with, in close proximity to, or integrated as part of the processor 610.

The processor 610 can include any general-purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include an output device 635, which can be one or more of a number of output mechanisms known to those of skill in the art. In some instances, multimodal systems can enable a user to provide multiple types of input/output to communicate with the computing system 600. The computing system 600 can include a communications interface 640, which can generally govern and manage the user input and system output. There is no restriction on operating on any particular hardware arrangement, and therefore the basic features here may easily be substituted for improved hardware or firmware arrangements as they are developed.

A storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as a processor 610, a connection 605, an output device 635, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled ata convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Select Examples

Example 1 provides a method for precise pick-up location determination, comprising: assigning a first autonomous vehicle to a user via a mobile device; determining an approximate pick-up location; determining, at a first wireless ranging technology unit, a first distance and a first angle between the mobile device and the first wireless ranging technology unit; determining, at a second wireless ranging technology unit, a second distance and a second angle between the mobile device and the second wireless ranging technology unit; and determining a mobile device location based on the first and second distances and the first and second angles, wherein the mobile device location is the precise pick-up location.

Example 2 provides a method according to one or more of the preceding and/or following examples, wherein determining the mobile device location further comprises performing triangulation using the first and second distances and the first and second angles.

Example 3 provides a method according to one or more of the preceding and/or following examples, further comprising communicating the first distance and the first angle from the first wireless ranging technology unit with the second wireless ranging technology unit.

Example 4 provides a method according to one or more of the preceding and/or following examples, further comprising communicating the first and second distances and the first and second angles from the first and second wireless ranging technology units with a central computing system.

Example 5 provides a method according to one or more of the preceding and/or following examples, further comprising communicating the first and second distances and the first and second angles from the first and second wireless ranging technology units with the mobile device.

Example 6 provides a method according to one or more of the preceding and/or following examples, further comprising sharing the mobile device location with the first autonomous vehicle.

Example 7 provides a method according to one or more of the preceding and/or following examples, further comprising determining, at the first autonomous vehicle, a stopping location based, at least in part, on the mobile device location.

Example 8 provides a method according to one or more of the preceding and/or following examples, wherein determining the first and second distances includes performing time of flight measurements.

Example 9 provides a system for user pick-up location determination in an autonomous vehicle fleet, comprising: a first autonomous vehicle; a central computing system configured to assign the first autonomous vehicle to a user via a mobile device for a user ride; a first wireless ranging technology unit configured to determine a first distance and a first angle between the user mobile device and the first wireless ranging technology unit; and a second wireless ranging technology unit configured to determine a second distance and a second angle between the user mobile device and the second wireless ranging technology unit; wherein the first and second distances and the first and second angles are used for the user pick-up location determination.

Example 10 provides a system according to one or more of the preceding and/or following examples, wherein at least one of the first autonomous vehicle, the central computing system, and the mobile device is configured to receive the first and second distances and the first and second angles and determine the user pick-up location.

Example 11 provides a system according to one or more of the preceding and/or following examples, wherein at least one of the first autonomous vehicle, the central computing system, and the mobile device is configured perform triangulation using the first and second distances and the first and second angles to determine the user pick-up location.

Example 12 provides a system according to one or more of the preceding and/or following examples, wherein first and second wireless ranging technology units include Ultra Wide Band transmitters.

Example 13 provides a system according to one or more of the preceding and/or following examples, wherein at least one of the first and second wireless ranging technology units is attached to a stationary structure.

Example 14 provides a system according to one or more of the preceding and/or following examples, wherein at least one of the first and second wireless ranging technology units is positioned on a second autonomous vehicle in the autonomous vehicle fleet.

Example 15 provides a system according to one or more of the preceding and/or following examples, wherein at least one of the first and second wireless ranging technology units is positioned in a second mobile device.

Example 16 provides a system according to one or more of the preceding and/or following examples, wherein the mobile device includes a rideshare application for the fleet of autonomous vehicles, and wherein the rideshare application is configured to activate user pick-up location determination.

Example 17 provides a system for user pick-up location determination in an autonomous vehicle, comprising: a central computing system including a routing coordinator configured to: receive a ride request from a mobile device including a pick-up location, and select a first autonomous vehicle for fulfilling the ride request; and an onboard computing system on the first autonomous vehicle configured to: receive a first distance and a first angle between the mobile device and a first wireless ranging technology unit, receive a second distance and a second angle between the mobile device and a second wireless ranging technology unit, and determine a mobile device location based on the first and second distances and the first and second angles.

Example 18 provides a system according to one or more of the preceding and/or following examples, wherein the onboard computing system is further configured to determine a stopping location based at least in part on the mobile device location.

Example 19 provides a system according to one or more of the preceding and/or following examples, wherein the onboard computing system is further configured to perform triangulation using the first and second distances and the first and second angles.

Example 20 provides a system according to one or more of the preceding and/or following examples, wherein the first and second wireless ranging technology units include Ultra Wide Band transmitters.

Variations and Implementations

According to various examples, driving behavior includes any information relating to how an autonomous vehicle drives. For example, driving behavior includes how and when the autonomous vehicle actuates its brakes and its accelerator, and how it steers. In particular, the autonomous vehicle is given a set of instructions (e.g., a route or plan), and the driving behavior determines how the set of instructions is implemented to drive the car to and from various destinations, and, potentially, to stop for passengers or items. Driving behavior may include a description of a controlled operation and movement of an autonomous vehicle and the manner in which the autonomous vehicle applies traffic rules during one or more driving sessions. Driving behavior may additionally or alternatively include any information about how an autonomous vehicle calculates routes (e.g., prioritizing fastest time vs. shortest distance), other autonomous vehicle actuation behavior (e.g., actuation of lights, windshield wipers, traction control settings, etc.) and/or how an autonomous vehicle responds to environmental stimulus (e.g., how an autonomous vehicle behaves if it is raining, or if an animal jumps in front of the vehicle). Some examples of elements that may contribute to driving behavior include acceleration constraints, deceleration constraints, speed constraints, steering constraints, suspension settings, routing preferences (e.g., scenic routes, faster routes, no highways), lighting preferences, “legal ambiguity” conduct (e.g., in a solid-green left turn situation, whether a vehicle pulls out into the intersection or waits at the intersection line), action profiles (e.g., how a vehicle turns, changes lanes, or performs a driving maneuver), and action frequency constraints (e.g., how often a vehicle changes lanes). Additionally, driving behavior includes information relating to whether the autonomous vehicle drives and/or parks.

As will be appreciated by one skilled in the art, aspects of the present disclosure, in particular aspects of a perception system for an autonomous vehicle, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for precise pick-up location determination, comprising:
assigning a first autonomous vehicle to a user via a mobile device;
determining an approximate pick-up location;
determining, at a first wireless ranging technology unit, a first distance and a first angle between the mobile device and the first wireless ranging technology unit;
determining, at a second wireless ranging technology unit, a second distance and a second angle between the mobile device and the second wireless ranging technology unit; and
determining a mobile device location based on the first and second distances and the first and second angles, wherein the mobile device location is the precise pick-up location.

2. The method of claim 1, wherein determining the mobile device location further comprises performing triangulation using the first and second distances and the first and second angles.

3. The method of claim 1, further comprising communicating the first distance and the first angle from the first wireless ranging technology unit with the second wireless ranging technology unit.

4. The method of claim 1, further comprising communicating the first and second distances and the first and second angles from the first and second wireless ranging technology units with a central computing system.

5. The method of claim 1, further comprising communicating the first and second distances and the first and second angles from the first and second wireless ranging technology units with the mobile device.

6. The method of claim 1, further comprising sharing the mobile device location with the first autonomous vehicle.

7. The method of claim 6, further comprising determining, at the first autonomous vehicle, a stopping location based, at least in part, on the mobile device location.

8. The method of claim 1, wherein determining the first and second distances includes performing time of flight measurements.

9. A system for user pick-up location determination in an autonomous vehicle fleet, comprising:
a first autonomous vehicle;
a central computing system configured to assign the first autonomous vehicle to a user via a mobile device for a user ride;
a first wireless ranging technology unit configured to determine a first distance and a first angle between the user mobile device and the first wireless ranging technology unit; and
a second wireless ranging technology unit configured to determine a second distance and a second angle between the user mobile device and the second wireless ranging technology unit;
wherein the first and second distances and the first and second angles are used for the user pick-up location determination.

10. The system of claim 9, wherein at least one of the first autonomous vehicle, the central computing system, and the mobile device is configured to receive the first and second distances and the first and second angles and determine the user pick-up location.

11. The system of claim 10, wherein at least one of the first autonomous vehicle, the central computing system, and the mobile device is configured perform triangulation using the first and second distances and the first and second angles to determine the user pick-up location.

12. The system of claim 9, wherein first and second wireless ranging technology units include Ultra Wide Band transmitters.

13. The system of claim 9, wherein at least one of the first and second wireless ranging technology units is attached to a stationary structure.

14. The system of claim 9, wherein at least one of the first and second wireless ranging technology units is positioned on a second autonomous vehicle in the autonomous vehicle fleet.

15. The system of claim 9, wherein at least one of the first and second wireless ranging technology units is positioned in a second mobile device.

16. The system of claim 9, wherein the mobile device includes a rideshare application for the fleet of autonomous vehicles, and wherein the rideshare application is configured to activate user pick-up location determination.

17. A system for user pick-up location determination in an autonomous vehicle, comprising:
a central computing system including a routing coordinator configured to:
receive a ride request from a mobile device including a pick-up location, and
select a first autonomous vehicle for fulfilling the ride request; and
an onboard computing system on the first autonomous vehicle configured to:
receive a first distance and a first angle between the mobile device and a first wireless ranging technology unit,
receive a second distance and a second angle between the mobile device and a second wireless ranging technology unit, and
determine a mobile device location based on the first and second distances and the first and second angles.

18. The system of claim 17, wherein the onboard computing system is further configured to determine a stopping location based at least in part on the mobile device location.

19. The system of claim 17, wherein the onboard computing system is further configured to perform triangulation using the first and second distances and the first and second angles.

20. The system of claim 19, wherein the first and second wireless ranging technology units include Ultra Wide Band transmitters.
